(19) United States
(12) Patent Application Publication
(10) Pub. No.: US 2008/0092715 A1
(43) Pub. Date: Apr. 24, 2008

(54) Movable Blade for Electrically Driven Tape Cutter

(76) Inventor: Kazuyoshi Omi, Saitama (JP)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(21) Appl. No.: 11/575,029

(22) PCT Filed: Apr. 1, 2005
(86) PCT No.: PCT/JP05/06511

§ 371 Date: Mar. 9, 2007

(51) Int. Cl. B27B 19/00

(52) U.S. Cl. 83/746

(57) ABSTRACT

A movable blade of a cutting unit installed in an electrically-driven tape cutter for automatically cutting fed tape is provided that inclines during cutting and stays horizontal during standby. The movable blade comprises two engagement holes for engagement with two projections formed to protrude in parallel from a frame. One engagement hole 20 has a substantially elliptical shape and the other engagement hole 30 has a substantially elliptical shape more elongated vertically from the same base height as the engagement hole 20.

### BACKGROUND OF THE INVENTION

1. Field of the Invention

This invention relates to a cutting mechanism of an electrically-driven tape cutter adapted to automatically pay out any of various kinds of tapes, particularly to a movable blade of an electrically-driven tape cutter that enables reliable tape cutting by means of a simple structure and can prevent entanglement.

2. Description of the Related Art

As an electrically-driven tape cutter, there has been developed a cutting device that automatically cuts and feeds out tape segments of predetermined length. The assignee is a developer of such electrically-driven tape cutter technologies and has applied for utility model protection thereof under, for example, Japanese Published Utility Model Application Nos. 6-13191 and 7-5087.

The electrically-driven tape cutter comprises a drive unit having a motor or the like driven by electricity, rollers, and a cutting mechanism. It is a device that operates the drive unit and rollers to automatically draw from of a tape loading unit tape wound on a basically round core, forward it to the cutting mechanism, cut it to a prescribed length at the outlet of the cutting mechanism, and feed it out. The configuration is such that once a tape segment automatically cut to the prescribed length by the electrically-driven tape cutter is taken out of the electrically-driven tape cutter main unit, the subsequent tape is automatically cut to the prescribed length and fed out of the tape cutting mechanism. It is piece of automatic equipment indispensable for use in various fields.

The electrically-driven tape cutter is equipped near the outlet with a cutting unit comprising a sharp blade and constituting the device for automatically cutting the tape. The movable blade installed in the conventional cutting unit is structured so that holes thereof for engagement with the frame can sleeve integrally onto projections of the frame and, therefore, it is necessary for ensuring reliable cutting of the tape to adopt a structure in which the blade is formed to incline beforehand and cuts progressively starting from one end thereof. With the movable blade of this structure, however, the movable blade sometimes entangles and draws in one end of the tape when it returns to the standby position following tape cutting.

A need has therefore been felt for the development of a movable blade capable of reliably cutting tape by a simple operation without entanglement.

Relevant prior art can be found in Japanese Unexamined Patent Application 11-235698

### SUMMARY OF THE INVENTION

The object of the present invention is to overcome the aforesaid problem by providing a movable blade for installation in an electrically-driven tape cutter, wherein one engagement hole of the movable blade is given a substantially elliptical shape elongated vertically so that the blade inclines during cutting and lies horizontal during standby.

In order to achieve the aforesaid object, the present invention provides a movable blade of an electrically-driven tape cutter, which is a movable blade of a cutting unit installed in an electrically-driven tape cutter for automatically cutting fed tape, comprising two engagement holes formed in the movable blade for engagement with two projections formed to protrude in parallel from a frame, one engagement hole 20 having a substantially elliptical shape and the other engagement hole 30 having a substantially elliptical shape more elongated vertically from the same base height as the engagement hole 20.

The aforesaid movable blade of an electrically-driven tape cutter can be the movable blade of a cutting unit installed in an electrically-driven tape cutter having a fixed blade and movable blade for automatically cutting fed tape, said movable blade being provided at two locations with parallel elongated holes of different length, whereby the movable blade maintains a horizontal state during standby and inclines during cutting to enable an action having a scissor effect. Further, a configuration can be adopted wherein the aforesaid action of the movable blade is achieved by driving the two projections protruding in parallel from the frame vertically in parallel to make the opposite lateral ends of the movable blade operate with a time lag.

Owing to the structure explained in the foregoing, the movable blade of an electrically-driven tape cutter according to the present invention offers the following merits:

1. One of the engagement holes of the movable blade that engage with the two projections of the frame is formed to have a vertically elongated elliptical shape and, therefore, cutting can be reliably achieved by the simple operation of the conventional cutting system and the tape can be maintained horizontal because the movable blade is held horizontal.

2. By providing the movable blade with parallel elongated holes of different length at two locations, it is possible to hold the movable blade horizontal in the standby position and to incline during cutting to produce an action having a scissor effect.

3. The movable blade is operated by driving the two projections protruding in parallel from the frame vertically in parallel, so that the opposite lateral ends of the movable blade can operate with a time lag.

### BRIEF DESCRIPTION OF THE DRAWINGS

FIG. 1 is a diagram showing a movable blade in a standby state

FIG. 2 is a diagram showing a projection of a frame in contact with one engagement hole of the movable blade.

FIG. 3 is diagram showing the projections of the frame in contact with both engagement holes of the movable blade.

FIG. 4 is a diagram showing the movable blade having risen to cut a tape.

FIG. 5 is a diagram showing a projection of the frame engaged with the bottom of one engagement hole of the movable blade at the start of movable blade descent.

FIG. 6 is a diagram showing the projections of the frame engaged with the bottoms of both engagement holes of the movable blade.

FIG. 7 is a diagram showing an example of a cutting unit installed in a conventional electrically-driven tape cutter.

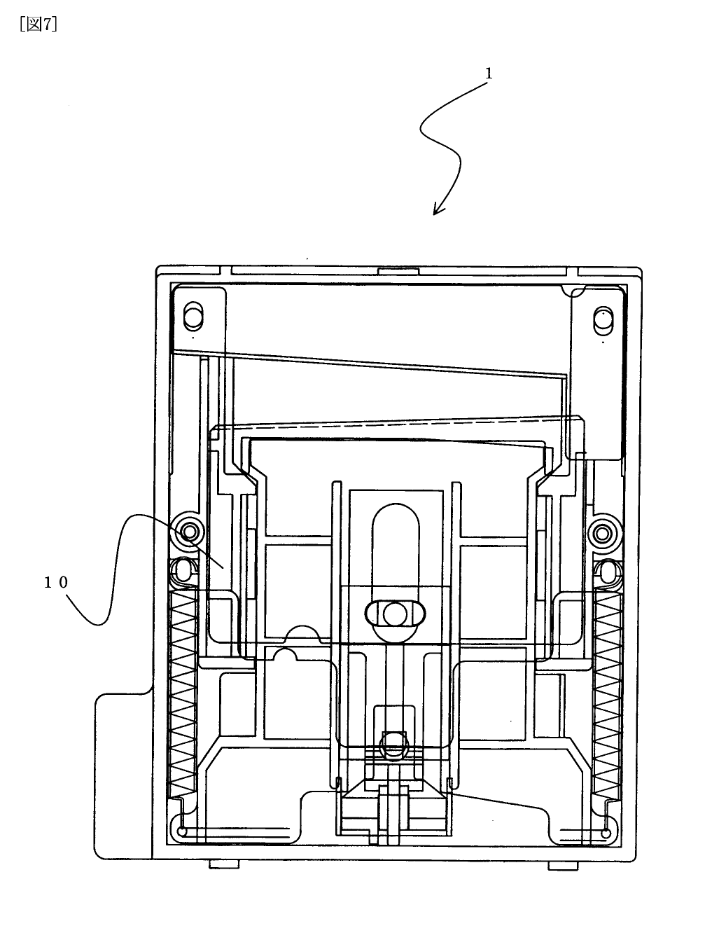

FIG. 8 is a perspective view of an electrically-driven tape cutter.

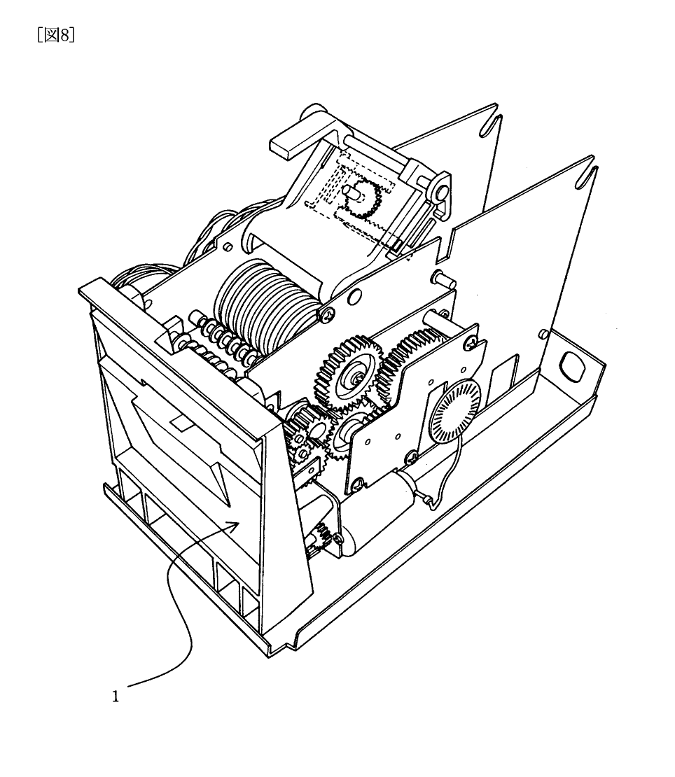

### DESCRIPTION OF THE PREFERRED EMBODIMENTS

The movable blade of an electrically-driven tape cutter according to the present invention will now be explained in detail in the following with reference to an embodiment shown in the drawings.

The cutting unit 1 of the electrically-driven tape cutter comprises a movable blade 10, a fixed blade 50, and other constituent members, including a shutter, stop, slider, elastic body and the like. The electrically-driven tape cutter movable blade 10 according to the present invention can be installed in the cutting unit 1 of electrically-driven tape cutters already in production. That is, the internal structure of the cutting unit is not particularly limited.

The electrically-driven tape cutter movable blade 10 comprises an engagement hole 20, an engagement hole 30 and a cutting edge 40.

The movable blade 10 is substantially rectangular and the cutting edge 40 is formed on the upper side of the rectangle. The movable blade moves vertically to make sliding contact with the fixed blade. The sliding contact (mating) of the movable blade and fixed blade cuts a tape.

The engagement hole 20 is formed near the bottom of the movable blade 10 to have a substantially elliptical shape. It operates in engagement with a projection 62 of a frame.

The engagement hole 30 is formed to have a substantially elliptical shape elongated vertically from the same height as the engagement hole 20. It operates in engagement with a projection 64 of the frame.

The individual engagement holes 20 and 30 need only to form a pair, and which is formed on which lateral side is arbitrary.

The operation of the electrically-driven tape cutter movable blade 10 will be explained in detail with reference to the drawings.

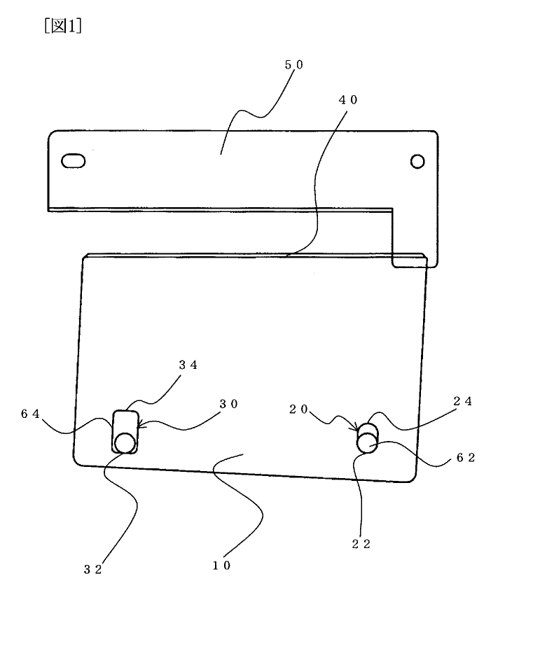

FIG. 1 shows the movable blade in the standby state, with the fixed blade 50 being installed above in an L-shaped configuration. The movable blade 10 stands by below, with the frame projections 62 and 64 in contact with the bottoms 22 and 32 of the engagement holes 20 and 30. In this state, the movable blade 10 stands by with an overall inclination that makes the cutting edge 40 lie horizontal.

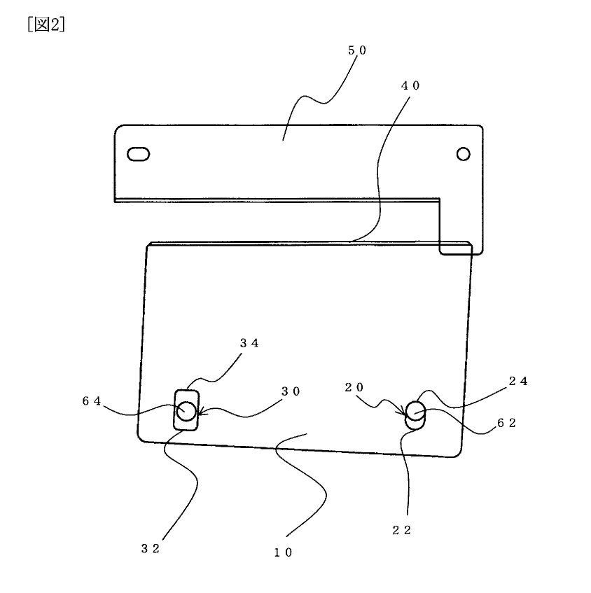

FIG. 2 shows the movable blade just before it begins to rise. When the frame projections 62 and 64 rise, the projection 62 first makes contact with the top 24 of the engagement hole 20 and then proceeds to lift the movable blade 10. At this time, the projection 64 engaged with the engagement hole 30, does not rise to the top 34 of the engagement hole 30 but remains at a midway point thereof because the engagement hole 30 has a substantially elliptical shape of long vertical length.

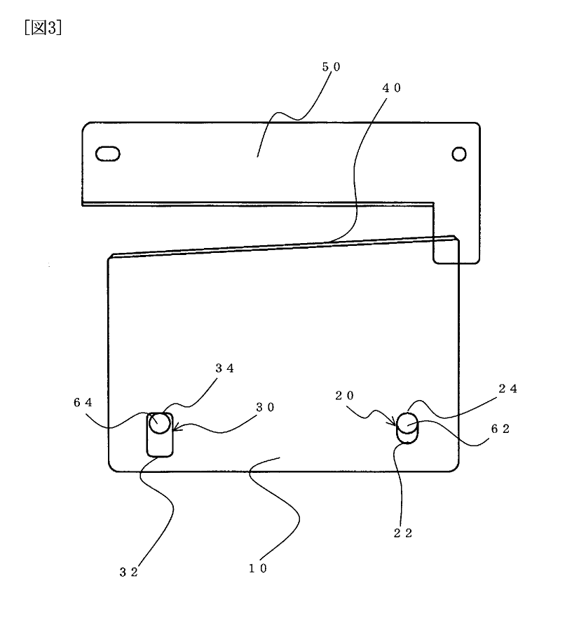

FIG. 3 shows the frame projections in the state of having made contact with the tops of both engagement holes. Once the projections 62 and 64 have ascended to the point that the projection 64 comes into contact with the top 34 of the engagement hole 30, the movable blade 10 becomes generally horizontal as a whole and thereafter rises as a whole with its cutting edge 40 in an inclined state.

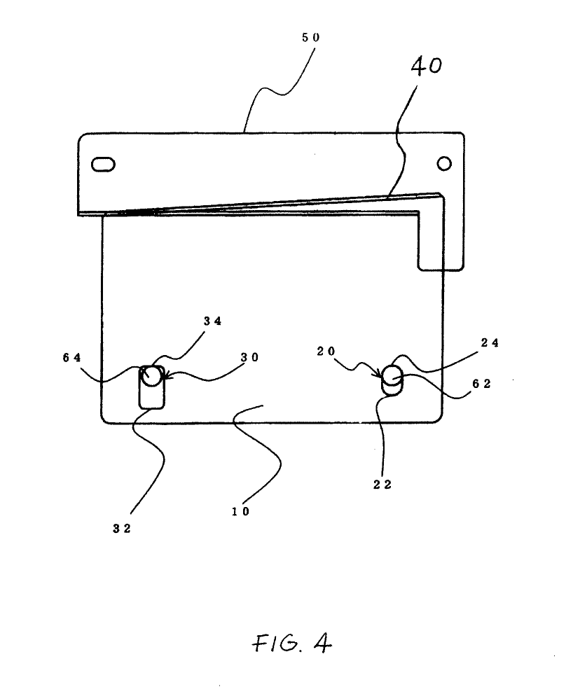

FIG. 4 shows the movable blade 10 having risen to the tape cutting position. As shown in FIG. 3, the cutting edge 40 of the movable blade ascends in an inclined state to cut tape by sliding contact with the fixed blade 50.

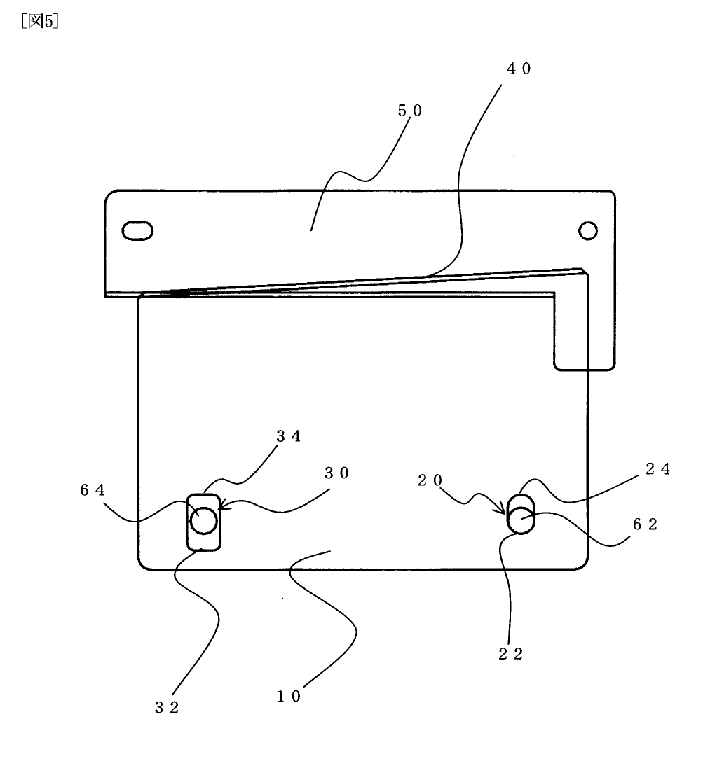

FIG. 5 shows the movable blade 10 after tape cutting and just before it begins to descend. The frame projection 62 is shown to have descended by the length of the engagement hole 20 to make contact with the bottom 22 thereof. At this time, only the engagement hole 20 side descends because the projection 64 has not yet come in contact with the bottom 32 of the engagement hole 30.

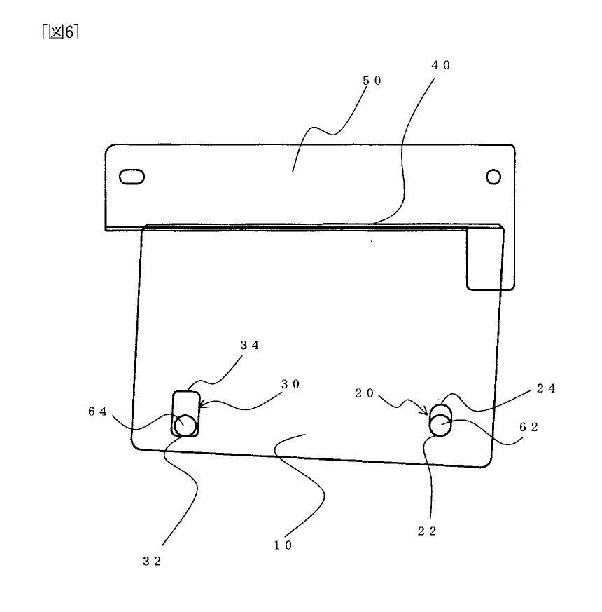

FIG. 6 shows the frame projections having come into contact with the bottoms of both engagement holes, thereby causing descent. After a certain amount of descent on the engagement hole 20 side, the frame projection 64 comes in contact with the bottom 32 of the engagement hole 30, whereafter the whole movable blade 10 descends to reestablish the state shown in FIG. 1. At this time, the cutting edge 40 can descend in a horizontal state because the locations of the bottoms of the engagement holes 20 and 30 differ.

The electrically-driven tape cutter movable blade 10 according to the present invention can be installed in products that have been available on the market heretofore and, in addition, makes it possible to supply an electrically-driven tape cutter capable of cutting tape by a simple operation, without need for any special modification.

Moreover, the fact that the cutting edge 40 is put in an inclined state at the time of cutting enables simple cutting, while the fact that the cutting edge 40 is held horizontal during descent ensures that the cut tape adhering to the movable blade 10 stays horizontal so that there is no danger of the tape being drawn into the machine when the movable blade descends. This offers the merit of the cut tape being easy to take out. This effect is particularly pronounced when the tape is cut to a short length.

What is claimed is:

1. A movable blade of an electrically-driven tape cutter, which is a movable blade of a cutting unit installed in an electrically-driven tape cutter having a fixed blade and a movable blade for automatically cutting fed tape, comprising:
two engagement holes formed in the movable blade for engagement with two projections formed to protrude in parallel from a frame, one engagement hole having a substantially elliptical shape and the other engagement hole having a substantially elliptical shape more elongated vertically from the same base height as the one engagement hole.

2. The movable blade of an electrically-driven tape cutter according to claim 1, wherein said movable blade is the movable blade of a cutting unit installed in an electrically-driven tape cutter having a fixed blade and a movable blade for automatically cutting fed tape, said movable blade being provided at two locations with parallel elongated holes of different length, whereby the movable blade maintains a horizontal state during standby and inclines during cutting to enable an action having a scissor effect.

3. The movable blade of an electrically-driven tape cutter according to claim 1, wherein the aforesaid action of the movable blade is achieved by driving the two projections protruding in parallel from the frame vertically in parallel to make the opposite lateral ends of the movable blade operate with a time lag.
